(19) United States
(12) Patent Application Publication
(10) Pub. No.: US 2017/0272890 A1
(43) Pub. Date: Sep. 21, 2017

(54) BINAURAL AUDIO SIGNAL PROCESSING METHOD AND APPARATUS REFLECTING PERSONAL CHARACTERISTICS

(71) Applicant: GAUDI AUDIO LAB, INC., Seoul (KR)

(72) Inventors: Hyunoh OH, Seongnam-si (KR); Taegyu LEE, Seoul (KR)

(73) Assignee: GAUDI AUDIO LAB, INC., Seoul (KR)

(21) Appl. No.: 15/611,800

(22) Filed: Jun. 2, 2017

Related U.S. Application Data
(63) Continuation of application No. PCT/KR2015/013152, filed on Dec. 3, 2015.

(30) Foreign Application Priority Data
Dec. 4, 2014 (KR) 10-2014-0173420

(51) Int. Cl. H04S 7/00

(52) U.S. Cl. CPC H04S 7/304; H04S 2420/01; H04S 2400/01

(57) ABSTRACT

Disclosed is an audio signal processing device. A personalization processor receives user information and outputs a binaural parameter for controlling binaural rendering based on the user information. A binaural renderer performs the binaural rendering on a source audio based on the binaural parameter.

### CROSS-REFERENCE TO RELATED APPLICATIONS

This application claims the benefit under 35 U.S.C. §120 and §365(c) to a prior PCT International Application No. PCT/KR2015/013152, filed on Dec. 3, 2015, which claims the benefit of Korean Patent Application No. 10-2014-0173420, filed on Dec. 4, 2014, the entire contents of which are incorporated herein by reference.

### DESCRIPTION

Technical Field

The present invention relates to an audio signal processing method and device. More specifically, the present invention relates to an audio signal processing method and device for synthesizing an object signal and a channel signal and effectively binaural-rendering a synthesized signal.

Background Art

3D audio commonly refers to a series of signal processing, transmission, encoding, and playback techniques for providing a sound which gives a sense of presence in a three-dimensional space by providing an additional axis corresponding to a height direction to a sound scene on a horizontal plane (2D) provided by conventional surround audio. In particular, the 3D audio requires a rendering technique for forming a sound image at a virtual position where a speaker does not exist even if a larger number of speakers or a smaller number of speakers than that for a conventional technique are used.

The 3D audio is expected to become an audio solution to an ultra high definition TV (UHDTV), and is expected to be applied to various fields of theater sound, personal 3D TV, tablet, wireless communication terminal, and cloud game in addition to sound in a vehicle evolving into a high-quality infotainment space.

Meanwhile, a sound source provided to the 3D audio may include a channel-based signal and an object-based signal. Furthermore, the sound source may be a mixture type of the channel-based signal and the object-based signal, and, through this configuration, a new type of listening experience may be provided to a user.

Binaural rendering is performed to model such a 3D audio into signals to be delivered to both ears of a human being. A user may experience a sense of three-dimensionality from a binaural-rendered 2-channel audio output signal through a headphone or an earphone. A specific principle of the binaural rendering is described as follows. A human being listens to a sound through two ears, and recognizes the location and the direction of a sound source from the sound. Therefore, if a 3D audio can be modeled into audio signals to be delivered to two ears of a human being, the three-dimensionality of the 3D audio can be reproduced through a 2-channel audio output without a large number of speakers.

Audio signals delivered to two ears are reflected by a human body so as to arrive at the eardrums. In this process, audio signals are delivered in different forms depending on human bodies. Therefore, audio signals delivered to two ears are significantly affected by a human body such as an ear shape. Accordingly, a human body feature significantly affects delivery of a sense of three-dimensionality through binaural rendering. Therefore, a user's body feature should be precisely reflected in a binaural rendering process so as to accurately perform binaural rendering.

### DISCLOSURE

### Technical Problem

An object of an embodiment of the present invention is to provide a binaural audio signal processing device and method for playing multi-channel or multi-object signals in stereo.

In particular, an object of an embodiment of the present invention is to provide a binaural audio signal processing device and method for efficiently reflecting a personal anthropometric feature.

### Technical Solution

An audio signal processing device according to an embodiment of the present invention includes: a personalization processor configured to receive user information and output a binaural parameter for controlling binaural rendering based on the user information; and a binaural renderer configured to perform the binaural rendering on a source audio based on the binaural parameter.

Here, the personalization processor may synthesize a first head related transfer function (HRTF) generated based on information on an HRTF actually measured and a second HRTF estimated by simulation to generate a personalized HRTF.

Here, the personalization processor may generate the personalized HRTF by using a frequency band higher than a first reference value of a frequency response according to the first HRTF and using a frequency band lower than a second reference value of a frequency response according to the second HRTF.

Here, the personalization processor may apply, to the first HRTF, a high pass filter which passes the frequency band higher than the first reference value, and may apply, to the second HRTF, a low pass filter which passes the frequency band lower than the second reference value.

Furthermore, the personalization processor may estimate the second HRTF based on at least one of a spherical head model, a snow man model, a finite-difference time-domain method, and a boundary element method.

Furthermore, the personalization processor may generate a personalized HRTF by simulating a notch of a frequency response according to an HRTF based on a distance between an entrance of an ear canal and a portion of an outer ear at which a sound is reflected and by applying a simulated notch.

Furthermore, the personalization processor may determine, among a plurality of HRTFs, an HRTF matched to an anthropometric feature which is most similar to a user's anthropometric feature corresponding to the user information, and may generate a determined HRTF as a personalized HRTF.

Here, the user's anthropometric feature may include information on a plurality of body portions, and the personalization processor may determine, among the plurality of HRTFs, the HRTF matched to the anthropometric feature which is most similar to the user's anthropometric feature based on weights assigned to the plurality of body portions respectively.

Furthermore, the personalization processor may decompose components of an individual HRTF for each feature of a frequency band or each feature of a time band, and may apply a user's anthropometric feature to the components of the individual HRTF decomposed for each feature of the frequency band or each feature of the time band.

Here, the user's anthropometric feature may include information on a plurality of body portions, and the personalization processor may decompose the individual HRF into a plurality of components matched to the plurality of body portions respectively, and may respectively apply, to the plurality of components, anthropometric features corresponding to the plurality of components respectively.

Here, the personalization processor may decompose the individual HRTF into a component matched to a form of an outer ear and a component matched to another body portion, wherein the other body portion may be a head or a torso.

Furthermore, the personalization processor may decompose the individual HRTF into the component matched to the form of the outer ear and the component matched to the other body portion through wave interpolation (WI).

Furthermore, the personalization processor divides a frequency response generated according to the individual HRTF into an envelope portion and a notch portion and applying a user's anthropometric feature to each of the envelope portion and the notch portion to generate a personalized HRTF.

Here, the personalization processor may change, according to the user's anthropometric feature, at least one of a frequency, a depth, and a width of a notch of the notch portion.

Furthermore, the personalization processor generates the personalized HRTF by assigning different weights to the same body portion in the envelope portion and the notch portion.

Here, when applying an anthropometric feature corresponding to a form of an outer ear to the notch portion, the personalization processor may assign a larger weight to the form of the outer ear than a weight assigned to the form of the outer ear when applying the anthropometric feature corresponding to the form of the outer eat to the envelope portion.

Furthermore, the personalization processor may extract a user's anthropometric feature based on the user information.

Here, the user information may be information obtained by measuring a user's body by a wearable device worn by a user.

Here, the user information may be image information containing an image of a user, and the personalization processor may model a form of an outer ear of the user from the image information or estimates a form of a head of the user from the image information.

Furthermore, the user information may be information on a size of clothes or accessory, and the personalization processor may extract the user's anthropometric feature based on the information on the size of clothes or accessory.

A method for processing a binaural audio signal according to an embodiment of the present invention includes the steps of: receiving user information; outputting a binaural parameter for controlling binaural rendering based on the user information; and performing the binaural rendering on a source audio based on the binaural parameter.

### Advantageous Effects

An embodiment of the present invention provides a binaural audio signal processing device and method for playing multi-channel or multi-object signals in stereo.

In particular, an embodiment of the present invention provides a binaural audio signal processing device and method for efficiently reflecting a personal feature.

### DESCRIPTION OF DRAWINGS

FIG. 1 is a block diagram illustrating a binaural audio signal processing device according to an embodiment of the present invention.

FIG. 2 is a block diagram illustrating a personalization processor according to an embodiment of the present invention.

FIG. 3 is a block diagram illustrating a personalization processor for extracting a user's anthropometric feature according to an embodiment of the present invention.

FIG. 4 illustrates a headphone extracting a user's anthropometric feature according to an embodiment of the present invention.

FIG. 5 is a block diagram illustrating a personalization processor which respectively applies weights to anthropometric features corresponding to a plurality of body portions respectively according to an embodiment of the present invention.

FIG. 6 illustrates a personalization processor which differentiates an envelope and a notch in frequency characteristics of a head related transfer function to reflect a user's anthropometric feature.

FIG. 7 illustrates a personalization processor which compensates a frequency response of a low-frequency band according to an embodiment of the present invention.

FIG. 8 illustrates that a sound delivered from a sound source is reflected by outer ears.

FIG. 9 illustrates a binaural audio signal processing method according to an embodiment of the present invention.

### MODE FOR CARRYING OUT THE INVENTION

Hereinafter, embodiments of the present invention will be described in detail with reference to the accompanying drawings so that the embodiments of the present invention can be easily carried out by those skilled in the art. However, the present invention may be implemented in various different forms and is not limited to the embodiments described herein. Some parts of the embodiments, which are not related to the description, are not illustrated in the drawings in order to clearly describe the embodiments of the present invention. Like reference numerals refer to like elements throughout the description.

When it is mentioned that a certain part “includes” certain elements, the part may further include other elements, unless otherwise specified.

The present application claims priority of Korean Patent Application No. 10-2014-0173420, the embodiments and descriptions of which are deemed to be incorporated herein.

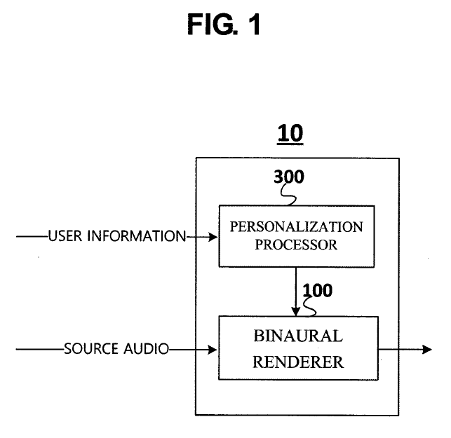

FIG. 1 is a block diagram illustrating a binaural audio signal processing device according to an embodiment of the present invention.

A binaural audio signal processing device 10 according to an embodiment of the present invention includes a personalization processor 300 and a binaural renderer 100.

The personalization processor 300 outputs a binaural parameter value to be applied to the binaural renderer, based on user information. Here, the user information may be information on an anthropometric feature of a user. The binaural parameter represents a parameter value for controlling binaural rendering. In detail, the binaural parameter may be a set value of a head related transfer function (HRTF) to be applied to binaural rendering or the HRTF itself. In the present invention, the HRTF includes a binaural room transfer function (BRTF). Here, the HRTF is a transfer function obtained by modeling a process in which a sound is transferred from a sound source positioned at a specific location to two ears of a human being. In detail, the HRTF may reflect influences of human head, torso, ears, etc. In a specific embodiment, the HRTF may be measured in an anechoic room. The personalization processor 300 may include information on the HRTF in a database form. The personalization processor 300 may be positioned in a separate server outside the binaural audio signal processing device 10 depending on a specific embodiment.

The binaural renderer 100 performs binaural rendering on a source audio based on the binaural parameter value, and outputs a binaural-rendered audio signal. Here, as described above, the binaural parameter value may be the set value of the HRTF or the HRTF itself. Furthermore, the source audio may be a mono audio signal or an audio signal including one object. In another embodiment, the source audio may be an audio signal including a plurality of objects or a plurality of channel signals.

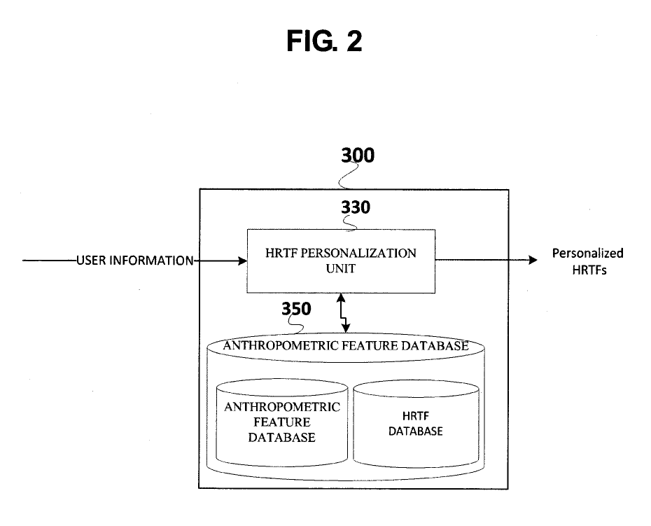

Specific operation of the personalization processor 300 will be described with reference to FIG. 2.

FIG. 2 is a block diagram illustrating a personalization processor according to an embodiment of the present invention.

The personalization processor 300 according to an embodiment of the present invention may include an HRTF personalization unit 330 and a personalization database 350.

The personalization database 350 stores information on an HRTF and an anthropometric feature. In detail, the personalization database 350 may store information on an HRTF matched to an anthropometric feature. In a specific embodiment, the personalization database 350 may include information on an HRTF actually measured. Furthermore, the personalization database 350 may include information on an HRTF estimated by simulation. A simulation technique used for estimating an HRTF may be at least one of a spherical head model (SHM) in which simulation is performed on the assumption that a human head is spherical, a snow man model in which simulation is performed on the assumption that a human head and torso are spherical, a finite-difference time-domain method (FDTDM), and a boundary element method (BEM). The SHM simulation is simulation method in which performed on the assumption that a human head is spherical. The personalization database 350 may be positioned in a separate server outside the binaural audio signal processing device 10 depending on a specific embodiment. In a specific embodiment, the anthropometric feature may include at least one of a form of an outer ear, a form of a torso, and a form of a head. Here, the form represents at least one of a shape and a size. Therefore, in this specification, measuring the form of specific body portion may represent measuring the shape or size of specific body portion.

The HRTF personalization unit 330 receives user information, and outputs a personalized HRTF corresponding to the user information. In detail, the HRTF personalization unit 330 may receive a user's anthropometric feature, and may output a personalized HRTF corresponding to the user's anthropometric feature. Here, the HRTF personalization unit 330 may receive, from the personalization database, information on an HRTF and an anthropometric feature required for outputting a personalized HRTF. In detail, the HRTF personalization unit 330 may receive, from the personalization database 350, information on an HRTF matched to an anthropometric feature, and may output a personalized HRTF corresponding to a user's anthropometric feature based on the received information on an HRTF matched to an anthropometric feature. For example, the HRTF personalization unit 330 may retrieve anthropometric feature data which is most similar to a user's anthropometric feature from among anthropometric feature data stored in the personalized database 350. The HRTF personalization unit 330 may extract, from the personalization database 350, an HRTF matched to the retrieved anthropometric feature data, and may apply the extracted HRTF to a binaural renderer.

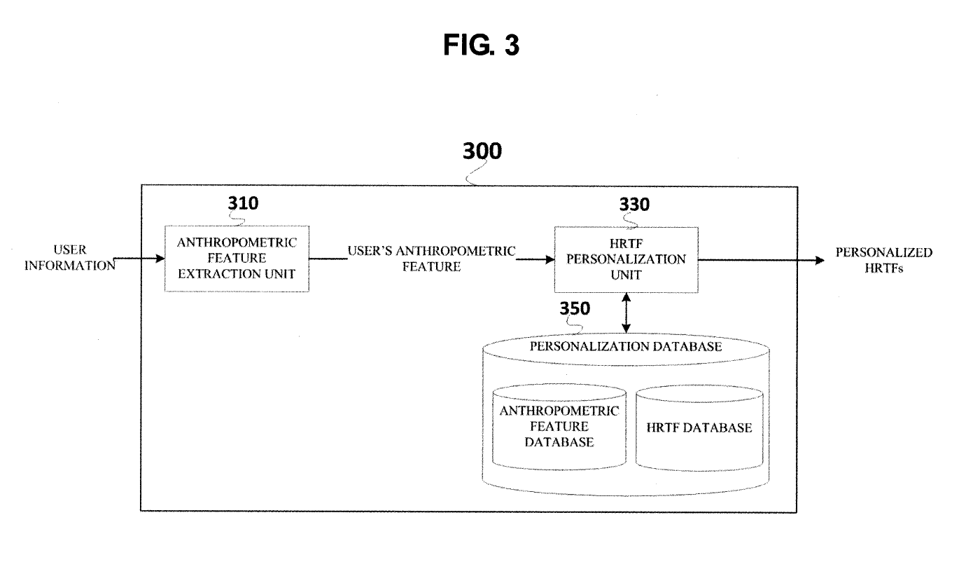

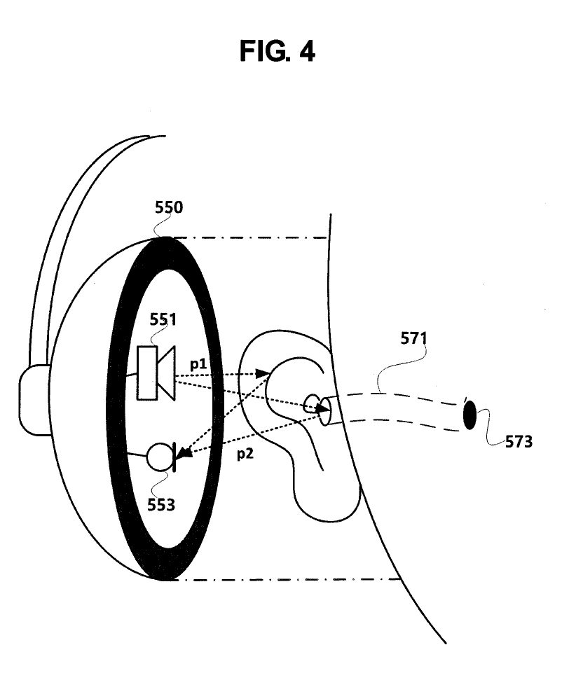

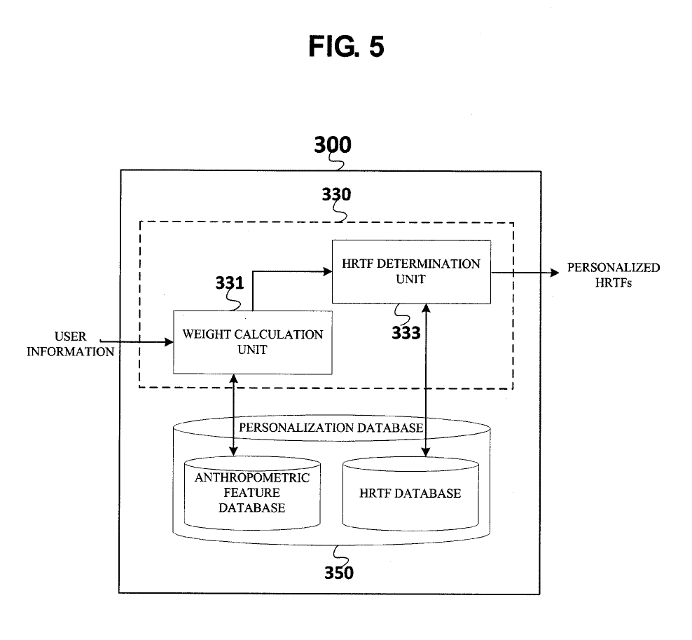

A specific method for extracting a user's anthropometric feature will be described with reference to FIGS. 3 and 4, and a specific method for outputting an HRTF personalized according to a user's feature will be described with reference to FIGS. 5 to 7.

FIG. 3 is a block diagram illustrating a personalization processor for extracting a user's anthropometric feature according to an embodiment of the present invention.

The personalization processor 300 according to an embodiment of the present invention may include an anthropometric feature extraction unit 310.

The anthropometric feature extraction unit 310 extracts a user's anthropometric feature from user information representing a user's feature. In detail, the user information may be image information. Here, the image information may include at least one of a video and a still image. The anthropometric feature extraction unit 310 may extract a user's anthropometric feature from the image information input by a user. Here, the image information may be obtained by capturing an image of a body of a user by using an externally installed camera.

Here, the camera may be a depth camera capable of measuring distance information. In a specific embodiment, the depth camera may measure a distance by using infrared light. In the case where the camera is the depth camera, the user information may include specific information on an outer ear. The specific information on an outer ear may represent a form of the outer ear. The form of the outer ear may include at least one of the size of the outer ear, the shape of the outer ear, and the depth of the outer ear. Since a reflection path is short when an audio signal is reflected by the outer ear, the outer ear affects a higher frequency band than that affected by another body portion. An audio frequency band affected by the outer ear is about 4-16 kHz, and forms a spectral notch. Even a small difference in the outer ear significantly affects the spectral notch, and the outer ear plays an important role for height perception. Therefore, when the user information includes outer ear information measured by using the depth camera, the personalization processor 300 may perform personalization more accurately.

In detail, the image information may be obtained by capturing an image of the body of the user by using a camera installed in a wireless communication terminal. Here, the wireless communication terminal may capture the image of the body of the user by using at least one of an accelerometer, gyro sensor, and a proximity sensor included in the wireless communication terminal. For example, the image information may be an image of a user's ear captured by using a front camera installed in the wireless communication terminal when the user moves the wireless communication terminal close to the user's ear to talk on the wireless communication terminal. In another specific embodiment, the image information may be a plurality of images of an ear captured at different viewing angles while increasing the distance between the wireless communication terminal and the ear after contacting the wireless communication terminal to the ear. Here, the wireless communication terminal may determine whether the communication terminal contacts the ear by using a proximity sensor included in the wireless communication terminal. Furthermore, the wireless communication terminal may detect at least one of the distance to the ear and a rotation angle by using at least one of an accelerometer and a gyro sensor. In detail, the wireless communication terminal may detect at least one of the distance to the ear and the rotation angle by using at least one of the accelerometer and the gyro sensor, after the wireless communication terminal contacts the ear. The wireless communication terminal may generate the image information which is a three-dimensional stereoscopic image representing the shape of the ear, based on at least one of the distance to the ear and the rotation angle.

Furthermore, the image information may be extracted using any one of ray scan methods for extracting a distance and a form. In detail, the image information may be obtained by scanning a user's body including an ear by using at least one of ultrasonic waves, near infrared light, and terahertz.

Furthermore, the image information may be obtained by 3D-modelling the shape of the outer ear of the user from a plurality of images containing the user. In a specific embodiment, the anthropometric feature extraction unit 310 may 3D-model the shape of the outer ear of the user from the plurality of images containing the user.

The anthropometric feature extraction unit 310 may estimate a head size from an image containing the user. Here, the anthropometric feature extraction unit 310 may estimate the head size by using a specific criterion or preset information from an image containing the user. Here, the specific criterion or preset information may be a size of a well-known object, a size of clothes, and a ratio between different persons. The size of a well-known object may be at least one of the size of a wireless communication terminal, the size of a signpost, the size of a building, and the size of a vehicle. For example, the anthropometric feature extraction unit 310 may estimate the head size of the user by calculating a ratio between the user's head and the wireless communication terminal contained in an image and based on a pre-stored size of the wireless communication terminal. Furthermore, the anthropometric feature extraction unit 310 may estimate, from the estimated head size, the shape and the size of an outer ear and an interaural distance, i.e., the distance between ears. This is because the shape and the size of an outer ear and the interaural distance, i.e., the distance between ears, correspond to the width of a head. In a specific embodiment, the image may be obtained from a social network service (SNS) account of the user. The image may be pre-stored in the wireless communication terminal of the user. This operation may free the user from experiencing inconvenience of measuring the body of the user and inputting measured information.

In another specific embodiment, the user information may be information on the size of clothes or accessory. Here, the anthropometric feature extraction unit 310 may estimate a user's anthropometric feature based on the information on the size of clothes or accessory. In detail, the anthropometric feature extraction unit 310 may estimate at least one of height, head width, chest size, and shoulder width based on the information on the size of clothes or accessory. In a specific embodiment, the information on the size of clothes or accessory may be size information of at least one of upper clothing, lower clothing, a hat, glasses, helmet, and goggles. Compared to the form of the outer ear, an anthropometric feature of a body portion other than the outer ear less affects a binaural rendering process. Therefore, it is less necessary to accurately estimate the anthropometric feature of a body portion other than the outer ear. Therefore, an anthropometric feature extraction process may be simplified by applying, to the binaural rendering, a value estimated using the information on the size of clothes or accessory.

In another specific embodiment, the HRTF personalization unit 330 may generate a personalized HRTF based on any one mode selected by the user from among of a plurality of modes. For example, the personalization processor 300 may receive, from the user, a user input for selecting one of the plurality of modes, and may output a binaural-rendered audio based on a selected user mode. Each of the plurality of modes may determine at least one of an interaural level difference (ILD), an interaural time difference (ITD), and a spectral notch to be applied to an HRTF. In detail, the HRTF personalization unit 330 may receive a user input for an interaural level difference, interaural time difference, and spectral notch level weight to be applied to an HRTF. Here, the user input for the interaural level difference, interaural time difference, and spectral notch level weight may be a user input for scaling the interaural level difference, interaural time difference, and spectral notch level weight.

A factor for increasing a sense of three-dimensionality changes depending on content to which binaural rendering is applied. For example, in the case of a flight simulation game, it is important for the user to perceive a height difference. In the case of a car racing game, it is important for the user to perceive front and rear spaces. Furthermore, a spectral notch feature applied to an HRTF is important for perceiving a height, and an interaural time difference and an interaural level difference are important for horizontal perception. Therefore, the user may select whether to emphasize horizontal perception or emphasize vertical perception during binaural rendering, by selecting one of the plurality of modes described above.

Furthermore, in a specific embodiment, an application for executing content may input, to the HRTF personalization unit 330, a mode optimized for the content.

In another specific embodiment, a sound output device worn by the user may measure the form of the ears of the user, and may input, to the personalization processor 300, the user information including the form of the ears of the user. This operation will be described in detail with reference to FIG. 4.

FIG. 4 illustrates a headphone extracting a user's anthropometric feature according to an embodiment of the present invention.

A sound output device 550 according to an embodiment of the present invention may measure the form of the ears of the user. In detail, the sound output device 550 worn by the user may measure the form of the ears of the user. Here, the sound output device 550 may be a headphone or an earphone.

In detail, the sound output device 550 may measure the form of the ears of the user by using a camera or a depth camera. In a specific embodiment, the embodiment described above with reference to FIG. 3 with regard to measuring a user's body by using a camera may be applied to the sound output device 550. In detail, the sound output device 550 may generate an image by photographing the ears of the user. Here, the sound output device 550 may use the generated ear image to recognize the user. In a specific embodiment, the sound output device 550 may recognize the user wearing the sound output device 550, based on the ear image of the user wearing the sound output device 550. Furthermore, the sound output device 550 may input information on the recognized user to the personalization processor 300. The personalization processor 300 may perform binaural rendering according to an HRTF set for the recognized user. In detail, the personalization processor 300 may search a database for user information matched to the ear image generated by the sound output device 550, and may find the user matched to the ear image generated by the sound output device 550. The personalization processor 300 may perform binaural rendering according to an HRTF set for the user matched to the generated ear image.

In another specific embodiment, the sound output device 550 may activate a function available only for a specific user based on the generated ear image. For example, when a current user's ear image generated by the sound output device 550 matches a stored image of a user, the sound output device 550 may activate a function of secret call through the sound output device 550. Here, secret call represents to encrypt the signal including call contents. This, method can prevent eavesdropping. Furthermore, when a current user's ear image generated by the sound output device 550 matches a stored image of a user, the sound output device 550 may activate a function of issuing or transferring a security code. Here, the security code represents a code used to identify an individual during a transaction which requires a high-level security, such as a financial transaction. Furthermore, when a current user's ear image generated by the sound output device 550 matches a stored image of a user, the sound output device 550 may activate a hidden application. Here, hidden application may represent an application which can be executed on a first mode and cannot be executed on a second mode. In a specific embodiment, the hidden application may represent an application executing a phone call to the specific person. In addition, hidden application may represent an application playing age-restricted content.

In another specific embodiment, the sound output device 550 may measure the size of the head of the user wearing the sound output device 550 by using a band for wearing the sound output device 550. In detail, the sound output device 550 may measure the size of the head of the user wearing the sound output device 550 by using a tension of the band for wearing the sound output device 550. Alternatively, the sound output device 550 may measure the size of the head based on an extension stage value of the band. In detail, the extension stage value of the band may be used for adjusting the length of the band, and may represent the length of the band.

The sound output device 550 may measure the ear form of the user based on an audio signal reflected from the outer ear of the user. In detail, the sound output device 550 may output a certain audio signal, and may receive the audio signal reflected from the ear of the user. Here, the sound output device 550 may measure the ear form of the user based on the received audio signal. In a specific embodiment, the sound output device 550 may receive an impulse response to an audio signal to measure an ear form. Here, the audio signal output from the sound output device 550 may be a signal designed in advance to measure the impulse response. In detail, the audio signal output from the sound output device 550 may be a pseudo noise sequence or a sine sweep. The audio signal output from the sound output device 550 may be an arbitrary music signal. In the case where the audio signal output from the sound output device 550 is an arbitrary music signal, the sound output device 550 may measure the ear form of the user when the user listens to music through the sound output device 550.

The personalization processor 300 may receive, from the sound output device 550, the audio signal reflected from the outer ear of the user, and may output a personalized HRTF based on the received audio signal.

A specific embodiment of the sound output device 550 which measures the ear form of the user based on the audio signal reflected from the outer ear of the user will be described with reference to FIG. 4. The sound output device 550 may include a speaker 551 which outputs an audio signal and a microphone 553 which receives the audio signal reflected from the outer ear. An ideal position of the microphone 553 for optimally measuring an HRTF from the audio signal reflected from the outer ear is the inside of an ear canal 571. In detail, an optimum position of the microphone 553 is an eardrum inside the ear canal. However, it is very difficult to install a microphone in the ear canal of the user, particularly, at the eardrum. Therefore, the microphone 553 is required to be positioned outside the ear canal, and an HRTF should be estimated by correcting a received audio signal according to the position of the microphone 553. In detail, the sound output device 550 may include a plurality of microphones 553, and the personalization processor 300 may generate a personalized HRTF based on audio signals received by the plurality of microphones 553. Here, the personalization processor 300 may store in advance information on the positions of the plurality of microphones 553 or may receive the information through a user input or the sound output device 550. In another specific embodiment, the position of the microphone 553 may be moved. Here, the personalization processor 300 may generate a personalized HRTF based on audio signals received by the microphone 553 at different positions.

The embodiment of the sound output device 550 described above may be equally applied to a wearable device worn by the user so as to be used. Here, the wearable device may be any one of a head mount display (HMD), a scout, goggles, and a helmet. Therefore, the wearable device worn by the user may measure the body of the user, and may input, to the personalization processor 300, the user information including the form of the body. Here, the form of the body of the user may include the form of the head and the form of the ears.

FIG. 5 is a block diagram illustrating a personalization processor which respectively applies weights to anthropometric features corresponding to a plurality of body portions respectively according to an embodiment of the present invention.

As described above, the HRTF personalization unit 330 may receive, from the personalization database 350, information on an HRTF matched to an anthropometric feature, and may output a personalized HRTF based on the received information on an HRTF matched to an anthropometric feature. For example, the HRTF personalization unit 330 retrieves anthropometric feature data which is most similar to a user's anthropometric feature from among the anthropometric feature data stored in the personalized database 350. The HRTF personalization unit 330 may extract, from the personalization database 350, an HRTF matched to the retrieved anthropometric feature data, and may apply the extracted HRTF to a binaural renderer. Herein, the anthropometric feature is related to a plurality of body portions. Accordingly, the anthropometric feature may include information on the plurality of body portions. However, the plurality of body portions of the body of the user differently affect a sound delivered to the ears of the user. In detail, the width of the head and the width of the torso more significantly affect the sound delivered to the ears of the user than the chest size. Furthermore, the outer ears more significantly affect the sound delivered to the ears of the user than the width of the torso.

Therefore, the HRTF personalization unit 330 may assign importance levels to the plurality of body portions, and may generate a personalized HRTF based on the importance levels assigned to the plurality of body portions respectively. In a specific embodiment, the HRTF personalization unit 330 may retrieve, based on the importance levels assigned to the body portions, anthropometric feature which is most similar to a user's anthropometric feature from among the anthropometric feature data stored in the personalized database 350. For the convenience of the explanation, an anthropometric feature which is most similar to a user's anthropometric feature is referred to matching anthropometric feature. In detail, the anthropometric feature may include information on the plurality of body portions, and may be matched to a single HRTF. Here, the HRTF personalization unit 330 may respectively assign importance levels to a plurality of body portions belonging to the anthropometric feature, and may determine, based on the importance levels assigned to the body portions, the matching anthropometric feature from among a plurality of anthropometric features stored in the personalized database 350. In the specific embodiment, when the HRTF personalization unit 330 determine the matching anthropometric feature, the HRTF personalization unit 330 may compare first a body portion having high importance level. For example, the HRTF personalization unit 330 may determine, as the matching anthropometric feature, an anthropometric feature of which a body portion having highest importance levels are most similar to those of the user, from among the plurality of anthropometric features stored in the personalization database 350. In another specific embodiment, the HRTF personalization unit 330 may select a plurality of body portions having high importance levels, to determine, as the matching anthropometric feature, an anthropometric feature of which the plurality of body portions having high importance levels are most similar to those of the user, from among the plurality of anthropometric features stored in the personalization database 350.

In a specific embodiment, the HRTF personalization unit 330 may generate a personalized HRTF without applying information on body portions having relatively low importance levels among the plurality of body portions. In detail, the HRTF personalization unit 330 may determine an anthropometric feature which is most similar to the user's anthropometric feature by comparing the plurality of body portions excepting the body portions having relatively low importance levels. Here, the body portions having relatively low importance levels may represent body portions having importance levels equal to or lower than a certain criterion. Alternatively, the body portions having relatively low importance levels may represent body portions having a lowest importance level.

As shown in the embodiment of FIG. 5, the HRTF personalization unit 330 may include a weight calculation unit 331 which calculates the weights for the plurality of body portions and an HRTF determination unit 333 which determines a personalized HRTF according to the calculated weights.

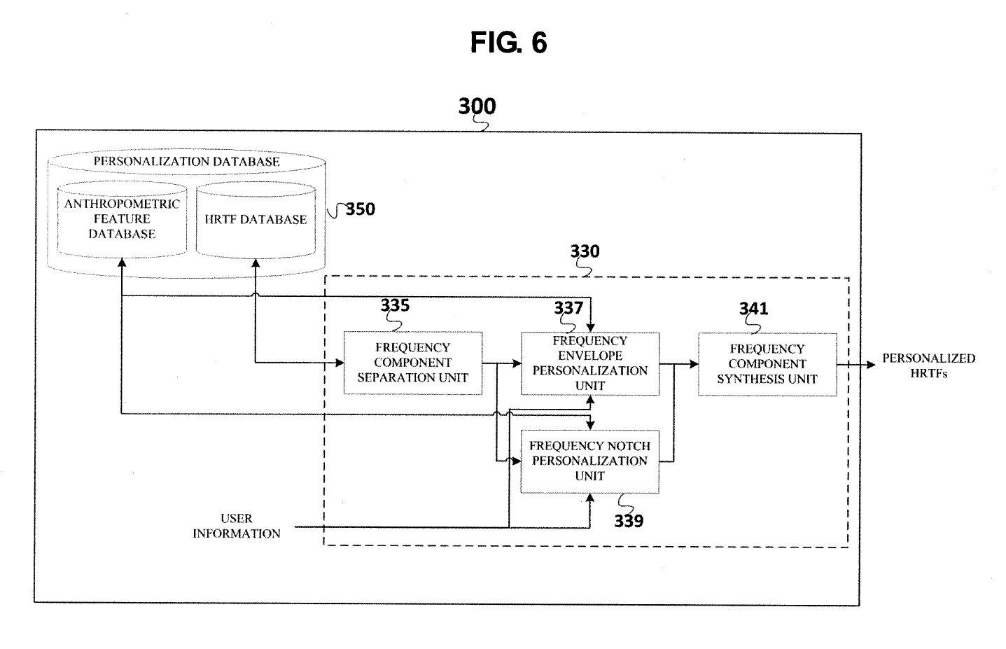

Described above with reference to FIGS. 4 and 5 is an embodiment in which the personalized processor 300 generates a personalized HRTF by using an individual HRTF. The individual HRTF represents an HRTF data set measured or simulated for an object having one anthropometric feature. The personalized processor 300 may decompose the individual HRTF into one or more components by each feature of a frequency band or each feature of a time band, and may combine or modify the one or more components to generate a personalized HRTF to which the user's anthropometric feature is applied. In an embodiment, the personalized processor 300 may decompose an HRTF into a pinna related transfer function (PRTF) and a head ex pinna related transfer function (HEPRTF), and may combine and modify the personalized HRTF the PRTF and the HEPRTF to generate the personalized HRTF. The PRTF represents a transfer function which models a sound delivered by reflecting from outer ear, the NPHRTF represents a transfer function which models a sound delivered by reflecting from the body excepting outer ear. In FIG. 6 this operation will be described.

FIG. 6 illustrates a personalization processor which differentiates an envelope and a notch in frequency characteristics of a head related transfer function to reflect a user's anthropometric feature.

The HRTF personalization unit 330 may generate the personalized HRTF by applying the user's anthropometric feature according to the frequency characteristics. In detail, the HRTF personalization unit 330 may generate the personalized HRTF by dividing a frequency response generated according to an HRTF into an envelope portion and a notch portion and applying the user's anthropometric feature to each of the envelope portion and the notch portion. Here, the HRTF personalization unit 330 may change, according to the user's anthropometric feature, at least one of a frequency, a depth, and a width of a notch in the frequency response according to the HRTF. In a specific embodiment, the HRTF personalization unit 330 may generate the personalized HRTF by dividing the frequency response generated according to the HRTF into the envelope portion and the notch portion and applying different weights to the same body portion in the envelope portion of the frequency response and the notch portion of the frequency response.

The reason why the HRTF personalization unit 330 performs this operation is that a body portion which mainly affects the notch portion of the frequency response generated according to the HRTF differs from a body portion which mainly affects the envelope portion. In detail, the form of the outer ears of the user mainly affects the notch portion of the frequency response generated according to the HRTF, and the head size and the torso size mainly affect the envelope portion of the frequency response generated according to the HRTF. Therefore, when applying the anthropometric feature to the notch portion of the frequency response, the HRTF personalization unit 330 may assign a larger weight to the form of the outer ears than a weight assigned to the form of the outer ears when applying the anthropometric feature to the envelope portion of the frequency response. Furthermore, when applying the anthropometric feature to the notch portion of the frequency response, the HRTF personalization unit 330 may assign a smaller weight to the form of the torso than a weight assigned to the form of the torso when applying the anthropometric feature to the envelope portion of the frequency response. Moreover, when applying the anthropometric feature to the notch portion of the frequency response, the HRTF personalization unit 330 may assign a smaller weight to the form of the head than a weight assigned to the form of the head when applying the anthropometric feature to the envelope portion of the frequency response.

In addition, when applying the anthropometric feature to the notch portion of the frequency response generated according to the HRTF, the HRTF personalization unit 330 may assign a larger weight to the form of the outer ears than that applied to the torso size or the head size. Furthermore, when applying the anthropometric feature to the envelope portion of the frequency response, the HRTF personalization unit 330 may assign a larger weight to the torso size or the head size than that applied to the form of the outer ears.

Here, the HRTF personalization unit 330 may not apply the anthropometric feature corresponding to a specific body portion in an individual frequency component, depending on assignment of a weight. For example, the HRTF personalization unit 330 may apply the anthropometric feature corresponding to the form of the outer ears to the notch portion of a frequency, but may not apply the anthropometric feature corresponding to the form of the outer ears to the envelope portion of the frequency. Here, the HRTF personalization unit 330 may apply, to the envelope portion of the frequency, the anthropometric feature corresponding to a body portion other than the outer ears.

Specific operation of the HRTF personalization unit 330 will be described with reference to FIG. 6.

In the embodiment of FIG. 6, a frequency component separation unit 335 separates the frequency response generated according to the HRTF into the envelope portion and the notch portion.

A frequency envelope personalization unit 337 applies the user's anthropometric feature to the envelope portion of the frequency response generated according to the HRTF. As described above, the frequency envelope personalization unit 337 may assign a larger weight to the torso size or the head size than that applied to the form of the outer ears.

A frequency notch personalization unit 339 applies the user's anthropometric feature to the notch portion of the frequency response generated according to the HRTF. As described above, the frequency notch personalization unit 339 may assign a larger weight to the form of the outer ears than that applied to the torso size or the head size.

A frequency component synthesis unit 341 generates the personalized HRTF based on an output from the frequency envelope personalization unit 337 and an output from the frequency notch personalization unit 339. In detail, the frequency component synthesis unit 341 generates the personalized HRTF corresponding to the envelope of the frequency generated by the frequency envelope personalization unit 337 and the notch of the frequency generated by the frequency notch personalization unit 339.

In a specific embodiment, the HRTF personalization unit 330 may separate the HRTF into a plurality of components corresponding to a plurality of body portions respectively, and may respectively apply, to the plurality of components, the anthropometric features corresponding to the plurality of components. In detail, the HRTF personalization unit 330 may extract the components of the HRTF matched to the anthropometric features corresponding to the plurality of body portions respectively. Here, the components, which comprise the individual HRTF, may represent a sound reflected from corresponding body portions and delivered to the ears of the user. The HRTF personalization unit 330 may generate the personalized HRTF by synthesizing the plurality of extracted components. In detail, the HRTF personalization unit 330 may synthesize the plurality of extracted components based on weights assigned to the plurality of components respectively. For example, the HRTF personalization unit 330 may extract a first component corresponding to the form of the outer ears, a second component corresponding to the head size, and a third component corresponding to the chest size. The HRTF personalization unit 330 may synthesize the first component, the second component, and the third component to generate the personalized HRTF. In this case, the personalization database 350 may store the components of the HRTF matched to the plurality of body portions respectively.

In particular, the HRTF personalization unit 330 may separate the HRTF into a component matched to the form of the outer ears and a component matched to the form of the head. Furthermore, the HRTF personalization unit 330 may separate the HRTF into the component matched to the form of the outer ears and a component matched to the form of the torso. This is because, when a sound is reflected from a human body and delivered to the ears, a time domain characteristic of the sound reflected by the outer ears is significantly different from a time domain characteristic of the sound reflected by the form of the head or the form of the torso.

Furthermore, the HRTF personalization unit 330 may separate a frequency component into a portion corresponding to the form of the outer ears and a portion corresponding to the form of the torso or the form of the head through homomorphic signal processing using a cepstrum. In another specific embodiment, the HRTF personalization unit 330 may separate the frequency component into the portion corresponding to the form of the outer ears and the portion corresponding to the form of the torso or the form of the head through low/high-pass filtering. In another specific embodiment, the HRTF personalization unit 330 may separate the frequency component into the portion corresponding to the form of the outer ears and the portion corresponding to the form of the torso or the form of the head through a wave interpolation (WI). Here, the wave interpolation may include rapidly evolving waveform (REW) and a slowly evolving waveform (SEW). This is because it may be assumed that a frequency response fast varies with a change of azimuth or elevation in the case of the outer ears, and the frequency response slowly varies with a change of azimuth or elevation in the case of the head or the torso. Azimuth or elevation represents an angle between a sound source and a center of two ears of a user.

In detail, when the WI is used, the HRTF personalization unit 330 may separate the frequency response according to the HRTF into the SEW and the REW in three-dimensional representation with space/frequency axes instead of time/frequency axes. In detail, the HRTF personalization unit 330 may separate the frequency response according to the HRTF into the SEW and the REW in three-dimensional representation having frequency/elevation or frequency/azimuth as axes. The HRTF personalization unit 330 may personalize the SEW by using the anthropometric features corresponding to the form of the head and the form of the torso. The HRTF personalization unit 330 may personalize the REW by using the anthropometric feature corresponding to the form of the outer ears. The REW may be expressed as a parameter representing the REW, and the HRTF personalization unit 330 may personalize the REW at a parameter stage. Furthermore, the SEW may be divided into components for the form of the head and the form of the torso, and the HRTF personalization unit 330 may personalize the SEW according to the anthropometric feature corresponding to the form of the head or the form of the torso. This is because it may be assumed that the component based on the form of the head or the form of the torso belongs to the SEW and the component based on the form of the outer ears belongs to the REW, as described above.

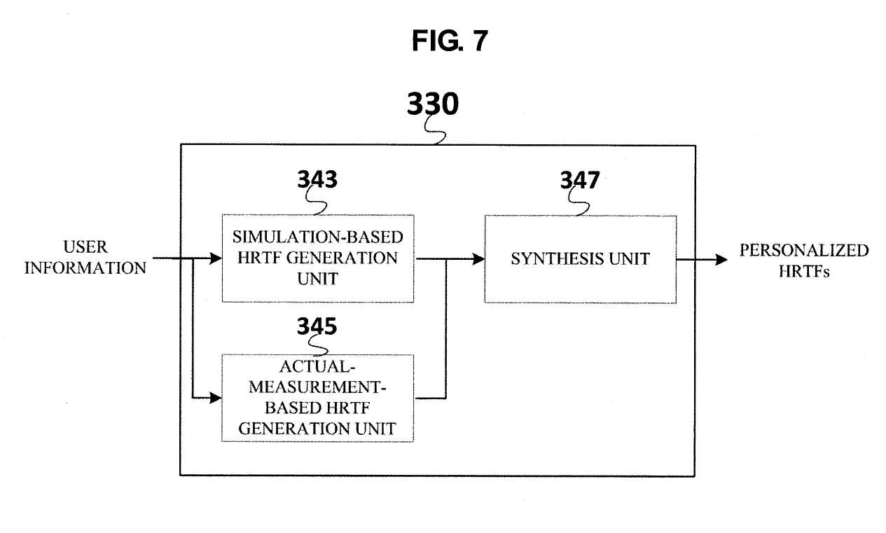

As described above, the personalization database 350 may include information on an HRTF actually measured. Furthermore, the personalization database 350 may include an HRTF estimated by simulation. The HRTF personalization unit 330 may generate the personalized HRTF based on the information on an HRTF actually measured and information on an HRTF estimated by simulation. This operation will be described with reference to FIG. 7.

FIG. 7 illustrates a personalization processor which compensates a frequency response of a low-frequency band according to an embodiment of the present invention.

The HRTF personalization unit 330 may generate a personalized HRTF by synthesizing an actual-measurement-based HRTF generated based on actually measured HRTF information and a simulation-based HRTF estimated by simulation. Here, the actual-measurement-based HRTF may be a personalized HRTF generated according to the user's anthropometric feature through the embodiments described above with reference to FIGS. 5 and 6. Furthermore, the simulation-based HRTF is generated through mathematical formulas or simulation methods. In detail, the simulation-based HRTF may be generated through at least one of the spherical head model (SHM), the snow man model, the finite-difference time-domain method (FDTDM), and the boundary element method (BEM) according to the user's anthropometric feature. In a specific embodiment, the HRTF personalization unit 330 may generate the personalized HRTF by combining mid-frequency and high-frequency components of the actual-measurement-based HRTF and a low-frequency component of the simulation-based HRTF. Here, the mid-frequency and high-frequency components may have frequency values equal to or larger than a first reference value. Furthermore, the low-frequency component may have a frequency value equal to or smaller than a second reference value. In detail, the first reference value and the second reference value may be the same value. In a specific embodiment, the HRTF personalization unit 330 may filter a frequency response of the actual-measurement-based HRTF by using a high pass filter, and may filter a frequency response of the simulation-based HRTF by using a low pass filter. This is because a low-frequency component of the frequency response of the actually measured HRTF significantly differs from a low-frequency component of a sound actually delivered to the ears of the user since it is difficult to measure a low-frequency component during an actual measurement process using a microphone. Furthermore, this is because a low-frequency component of the HRTF estimated by simulation is similar to the low-frequency component of the sound actually delivered to the ears of the user.

Furthermore, in a specific embodiment, the HRTF personalization unit 330 may differentiate processing bands of the actual-measurement-based HRTF and the simulation-based HRTF through a filter bank such as a quadrature mirror filter or fast Fourier transform (FFT).

In the embodiment of FIG. 7, the HRTF personalization unit 330 includes a simulation-based HRTF generation unit 343, an actual-measurement-based HRTF generation unit 345, and a synthesis unit 347.

The simulation-based HRTF generation unit 343 performs simulation according to the user's anthropometric feature to generate a simulation-based HRTF.

The actual-measurement-based HRTF generation unit 345 generates an actual-measurement-based HRTF according to the user's anthropometric feature.

The synthesis unit 347 generates the simulation-based HRTF and the actual-measurement-based HRTF. In detail, the synthesis unit 347 may synthesize mid-frequency and high-frequency components of the actual-measurement-based HRTF and a low-frequency component of the simulation-based HRTF to generate a personalized HRTF. In a specific embodiment, the synthesis unit 347 may filter the frequency response of the actual-measurement-based HRTF by using a high pass filter, and may filter the frequency response of the simulation-based HRTF by using a low pass filter.

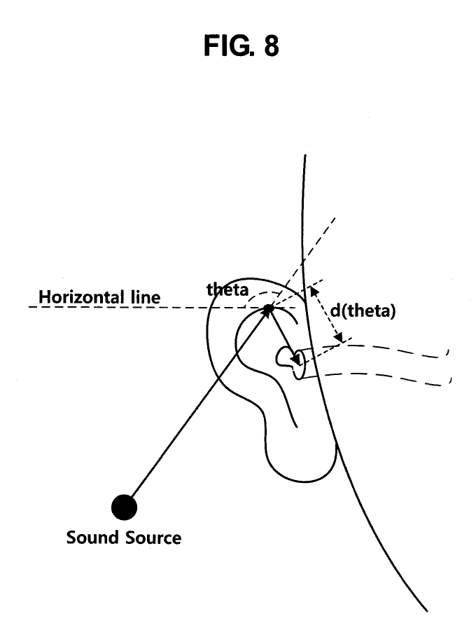

As described above, the user's anthropometric feature considered for generating a personalized HRTF may include the form of the outer ears. Furthermore, the form of the outer ears significantly affects the notch of a frequency response according to an HRTF. Described below with reference to FIG. 8 is a method for simulating, based on the form of the outer ears, the notch of the frequency response according to the HRTF.

FIG. 8 illustrates that a sound delivered from a sound source is reflected by the outer ears.

The HRTF personalization unit 330 may simulate the notch of the frequency response according to the HRTF, based on the form of the outer ears. Here, the form of the outer ears may represent at least one of the size and the shape of the outer ears. Furthermore, the form of the outer ears may include at least one of a helix, a helix border, a helix wall, a concha border, an antihelix, a concha wall, and a crus helias. The HRTF personalization unit 330 may simulate the notch of the frequency response according to the HRTF, based on the distance between an entrance of the ear canal and a portion of the outer ear at which the sound is reflected. In detail, the HRTF personalization unit 330 may simulate the notch of the frequency response according to the HRTF, based on the speed of sound and the distance between the entrance of the ear canal and the portion of the outer ear at which the sound is reflected. In detail, the HRTF personalization unit 330 may simulate the notch of the frequency response according to the HRTF, through the following equation.

f(theta)=c/(2*d(theta))

f(theta) denotes a frequency of the notch of the frequency response according to the HRTF, and theta denotes elevation, and c denotes the speed of sound, and d(theta) denotes the distance between the entrance of the ear canal and the portion of the outer ear at which the sound is reflected. Here, the elevation may represent an angle between a straight line passing through the location of the sound source and the portion of the outer ear at which the sound is reflected and a horizontal reference plane, as measured in an upward direction. In a specific embodiment, the elevation may be expressed as a negative number when it is equal to or larger than 90 degrees.

The HRTF personalization unit 330 may generate the personalized HRTF by applying a simulated notch. In detail, the HRTF personalization unit 330 may generate a notch/peak filter based on the simulated notch. The HRTF personalization unit 330 may apply a generated notch/peak filter to generate the personalized HRTF.

In another specific embodiment, the personalization processor 300 may input the notch/peak filter to the binaural renderer 100, and the binaural renderer 100 may filter a source audio through the notch/peak filter.

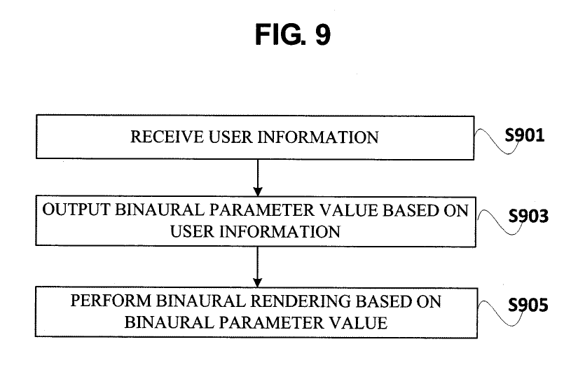

FIG. 9 illustrates a binaural audio signal processing operation according to an embodiment of the present invention.

The personalization processor 300 receives user information (S901). Here, the user information may include information on a user's anthropometric feature. Here, the anthropometric feature may include at least one of a form of an external ear, a form of a torso, and a form of a head. Here, the form may represent at least one of the size and the shape. Furthermore, the user information may indicate any one of a plurality of binaural rendering modes selected by the user. Furthermore, the user information may indicate any one of the plurality of binaural rendering modes selected by an application executed by the user. In detail, the user information may be image information for estimating the user's anthropometric feature. In another specific embodiment, the user information may be information on size of clothes or accessory.

A binaural parameter represents a parameter value for controlling binaural rendering. Furthermore, the binaural parameter may be a set value of a binaural HRTF or the HRTF itself.

The personalization processor 300 outputs a binaural parameter value based on user information (S903). Here, the personalization processor 300 may extract the user's anthropometric feature from the user information. In detail, the personalization processor 300 may extract the user's anthropometric feature from the user information through the embodiments described above with reference to FIGS. 3 and 4. In detail, the personalization processor 300 may extract the user's anthropometric feature using image information. In a specific embodiment, the personalization processor 300 may model the form of the outer ears from a plurality of images containing the outer ears of the user. In another specific embodiment, the personalization processor 300 may model the form of the head of the user from a plurality of images containing the head of the user. Furthermore, as described above, the personalization processor 300 may measure the form of the ears of the user by using a sound output device. In particular, the sound output device 550 may measure the ear form of the user based on an audio signal reflected from the outer ear of the user. Furthermore, the personalization processor 300 may measure the form the body of user by using a wearable device. Here, the wearable device may be any one of a head mount display (HMD), a scout, goggles, and a helmet.

In another specific embodiment, the personalization processor 300 may extract the user's anthropometric feature from the size of clothes or accessory.

In detail, the personalization processor 300 may generate a personalized HRTF based on the user information through the above-described embodiments. In detail, the personalization processor 300 may generate the personalized HRTF by synthesizing an actual measurement based HRTF generated based on the extracted anthropometric features and a simulated based HRTF. The personalization processor 300 may generate the personalized HRTF by using a frequency band higher than a first reference value of a frequency response according to the actual-measurement-based HRTF and using a frequency band lower than a second reference value of a frequency band according to the simulation-based HRTF. The personalization processor 300 may estimate the simulation-based HRTF based on at least one of the spherical head model in which simulation is performed on the assumption that a human head is spherical, the snow man model in which simulation is performed on the assumption that a human head and torso are spherical, the finite-difference time-domain method, and the boundary element method. The personalization processor 300 may simulate the notch of the frequency response according to the HRTF, based on the distance between the entrance of the ear canal and a portion of the outer ear at which a sound is reflected, and may generate the personalized HRTF by applying the simulated notch.

Furthermore, the personalization processor 300 may determine, among a plurality of HRTFs, an HRTF matched to an anthropometric feature which is most similar to the user's anthropometric feature corresponding to the user information, and may generate the determined HRTF as the personalized HRTF or the actual-measurement-based HRTF. The user's anthropometric feature may include information on a plurality of body portions, and the personalization processor 300 may determine, among the plurality of HRTFs, an HRTF matched to an anthropometric feature which is most similar to the user's anthropometric feature based on weights assigned to the plurality of body portions respectively.

Furthermore, the personalization processor 300 may decompose components of an individual HRTF for each feature of a frequency band or each feature of a time band, and may apply the user's anthropometric feature to the components of the individual HRTF decomposed for each feature of the frequency band or each feature of the time band. In detail, the user's anthropometric feature may include information on a plurality of body portions, and the personalization processor 300 may decompose the individual HRF into a plurality of components matched to the plurality of body portions respectively, and may respectively apply, to the plurality of components, the anthropometric features corresponding to the plurality of components. In a specific embodiment, the personalization processor 300 may decompose the individual HRTF into a component matched to the form of the outer ears and a component matched to another body portion. Here, the other body portion may be the form of the head or the form of the torso.

Furthermore, the personalization processor 300 may decompose the individual HRTF into the component matched to the form of the outer ears and the component matched to the other body portion through wave interpolation (WI). In detail, the personalization processor 300 may decompose the individual HRTF into a SEW and a REW through the wave interpolation. Here, the personalization processor 300 may personalize the REW by using the anthropometric feature corresponding to the form of the outer ears. Furthermore, the personalization processor 300 may personalize the SEW by using the anthropometric feature corresponding the form of the head or the form of the torso.

In another specific embodiment, the personalization processor 300 may separate a frequency component into a portion corresponding to the form of the outer ears and a portion corresponding to the form of another body portion through homomorphic signal processing using a cepstrum. In another specific embodiment, the personalization processor 300 may separate the frequency component into the portion corresponding to the form of the outer ears and the portion corresponding to the form of another body portion through low/high-pass filtering. Here, the other body portion may be the head or the torso.

Furthermore, the personalization processor 300 may generate the personalized HRTF by dividing a frequency response generated according to an individual HRTF into an envelope portion and a notch portion and applying the user's anthropometric feature to each of the envelope portion and the notch portion. In detail, the personalization processor may change, according to the user's anthropometric feature, at least one of a frequency, a depth, and a width of a notch of the notch portion. The personalization processor 300 may generate the personalized HRTF by assigning different weights to the same body portion. In detail, when applying the anthropometric feature to the notch portion of the frequency response, the HRTF personalization unit 330 may assign a larger weight to the form of the outer ears than a weight assigned to the form of the outer ears when applying the anthropometric feature to the envelope portion of the frequency response. Furthermore, when applying the anthropometric feature to the notch portion of the frequency response, the HRTF personalization unit 330 may assign a smaller weight to the form of the torso than a weight assigned to the form of the torso when applying the anthropometric feature to the envelope portion of the frequency response. Furthermore, when applying the anthropometric feature to the notch portion of the frequency response, the HRTF personalization unit 330 may assign a smaller weight to the form of the head than a weight assigned to the form of the head when applying the anthropometric feature to the envelope portion of the frequency response.

The binaural renderer 100 performs binaural rendering on a source audio based on the binaural parameter value (S905). In detail, the binaural renderer 100 may perform binaural rendering on the source audio based on the personalized HRTF.

Although the present invention has been described using the specific embodiments, those skilled in the art could make changes and modifications thereto without departing from the spirit and the scope of the present invention. That is, although the embodiments of binaural rendering for multi-audio signals have been described, the present invention can be equally applied and extended to various multimedia signals including not only audio signals but also video signals. Therefore, any derivatives that could be easily inferred by those skilled in the art from the detailed description and the embodiments of the present invention should be construed as falling within the scope of right of the present invention.

1. An audio signal processing device comprising:
a personalization processor configured to receive user information, decompose components of an head related transfer function(HRTF) for each feature of a frequency band or each feature of a time band, apply the user information to the components of the HRTF decomposed for each feature of the frequency band or each feature of the time band to generate a personalized HRTF, and output a binaural parameter for controlling binaural rendering, wherein the binaural parameter includes information on the personalized HRTF; and
a binaural renderer configured to perform the binaural rendering on a source audio based on the binaural parameter.

2. The audio signal processing device of claim 1, wherein the personalization processor synthesize a first HRTF generated based on information on an HRTF actually measured and a second HRTF estimated by simulation to generate the personalized HRTF.

3. The audio signal processing device of claim 2, wherein the personalization processor generates the personalized HRTF by using a frequency band higher than a first reference value of a frequency response according to the first HRTF and using a frequency band lower than a second reference value of a frequency response according to the second HRTF.

4. The audio signal processing device of claim 3, wherein the personalization processor applies, to the first HRTF, a high pass filter which passes the frequency band higher than the first reference value, and applies, to the second HRTF, a low pass filter which passes the frequency band lower than the second reference value.

5. The audio signal processing device of claim 2, wherein the personalization processor estimates the second HRTF based on at least one of a spherical head model, a snow man model, a finite-difference time-domain method, and a boundary element method.

6. The audio signal processing device of claim 1, wherein the personalization processor generates a personalized HRTF by simulating a notch of a frequency response according to an HRTF based on a distance between an entrance of an ear canal and a portion of an outer ear at which a sound is reflected and by applying a simulated notch.

7. The audio signal processing device of claim 1, wherein the user information includes a user's anthropometric feature.

8. The audio signal processing device of claim 7,
wherein the user's anthropometric feature comprises information on a plurality of body portions,
wherein the personalization processor decomposes the HRTF into a plurality of components matched to the plurality of body portions respectively, and respectively applies, to the plurality of components, anthropometric features corresponding to the plurality of components respectively.

9. The audio signal processing device of claim 8,
wherein the personalization processor decomposes the HRTF into a component matched to a form of an outer ear and a component matched to another body portion,
wherein the other body portion is a head or a torso.

10. The audio signal processing device of claim 9, wherein the personalization processor decomposes the HRTF into the component matched to the form of the outer ear and the component matched to the other body portion based on at least one of homomorphic signal processing, low/high pass filter, and wave interpolation (WI).

11. The audio signal processing device of claim 7, wherein the personalization processor divides a frequency response generated according to the HRTF into an envelope portion and a notch portion and applies a user's anthropometric feature to each of the envelope portion and the notch portion to generate a personalized HRTF.

12. The audio signal processing device of claim 11, wherein the personalization processor changes, according to the user's anthropometric feature, at least one of a frequency, a depth, and a width of a notch of the notch portion.

13. The audio signal processing device of claim 11, wherein the personalization processor assigns different weights to the same body portion in the envelope portion and the notch portion to generate the personalized HRTF.

14. The audio signal processing device of claim 13, wherein, when applying an anthropometric feature corresponding to a form of an outer ear to the notch portion, the personalization processor assigns a larger weight to the form of the outer ear than a weight assigned to the form of the outer ear when applying the anthropometric feature corresponding to the form of the outer ear to the envelope portion.

15. The audio signal processing device of claim 1, wherein the personalization processor extracts a user's anthropometric feature based on the user information.

16. The audio signal processing device of claim 15, wherein the user information is estimated by a wearable device worn by the user,
wherein the wearable device includes a band which is worn at user's head.

17. The audio signal processing device of claim 16, wherein the user information is estimated by a tension of the band.

18. The audio signal processing device of claim 16, wherein the user information is estimated by an extension stage value of the band.

19. The audio signal processing device of claim 15,
wherein the user information is image information containing an image of a user,
wherein the personalization processor models a form of an outer ear of the user from the image information or estimates a form of a head of the user from the image information.

20. The audio signal processing device of claim 15,
wherein the user information is clothes size information,
wherein the personalization processor extracts the user's anthropometric feature based on the clothes size information.
